(19) United States
(12) Patent Application Publication
(10) Pub. No.: US 2009/0269149 A1
(43) Pub. Date: Oct. 29, 2009

(54) CONVEYOR DEVICE FOR POWDER MATERIALS

(75) Inventor: Peter Hilgraf, Hamburg (DE)

Correspondence Address: MORRISON & FOERSTER LLP, 1650 TYSONS BOULEVARD, SUITE 400, MCLEAN, VA, 22102, US

(73) Assignee: Claudius Peters Technologies GmbH, Buxtehude (DE)

(21) Appl. No.: 12/439,461

(22) PCT Filed: Aug. 31, 2007
(86) PCT No.: PCT/EP07/07638

§ 371 Date: Feb. 27, 2009

(30) Foreign Application Priority Data
Aug. 31, 2006 (EP) 06018220.1

(51) Int. Cl. B65G 53/40

(52) U.S. Cl. 406/155

(57) ABSTRACT

An apparatus for pneumatically conveying bulk material comprising a conveying pipe, a conveying gas source, and a plurality of removal points. The conveying pipe forms a conveying path for the bulk material. The conveying gas source is connected to the conveying pipe and is configured to supply conveying gas in the direction of the conveying path. The removal points allow gas to be removed from the conveying pipe. The removal points are arranged on the conveying pipe at a distance from one another along the conveying path, and are adjustable in terms of quantity of gas flow to be removed from the conveying pipe. Controlled removal of excess gas from the conveying pipe can therefore be achieved to reduce the gas velocity, such that the conveying remains steady and stable without a stepwise increase in the cross section of the conveying pipe along the conveying path.

### REFERENCE TO RELATED APPLICATIONS

This application is a national stage application under 35 USC 371 of International Application No. PCT/EP2007/007638, filed Aug. 31, 2007, which claims priority of European Patent Application No. 06018220.1, filed Aug. 31, 2006, the contents of which are incorporated herein be reference in their entirety.

### FIELD OF THE INVENTION

The invention relates to an apparatus for pneumatically conveying bulk material, with a conveying pipe which determines a conveying path for the bulk material, a conveying gas source which is connected to the conveying pipe and is designed for supplying conveying gas in the direction of the conveying path, and at least one removal point via which gas is removed from the conveying pipe.

### BACKGROUND OF THE INVENTION

Conveying apparatuses with closed conveying lines for transporting bulk material, in particular pulverulent material, have long been known. A conveying-gas supply device is generally provided in order also to be able to convey the material independently of gravitational force. To this end, conveying gas is fed in at one end of the conveying line via a source, said conveying gas flowing in the conveying direction through the conveying line and, in the process, entraining the bulk material which is to be conveyed. In the case of longer conveying distances or in the case of more difficult transport conditions, it is generally inadequate to provide just one conveying-gas supply. Therefore, there are generally a plurality of conveying-gas supply means along the conveying line. In order to improve the transport behaviour of the bulk material, the bulk material is furthermore frequently also fluidized. For this purpose, fluidizing devices are arranged, either individually or continuously, along the conveying line. Fluidizing gas is supplied through them in order to transfer the bulk material into a liquid-like state and therefore make it more easily transportable. The gas volume increases along the conveying distance, to be precise, at least because of expansion of the gas and optionally also because of further supplying of conveying gas and/or fluidizing gas along the conveying distance.

In order to control the gas volume rising along the conveying distance, it is known to increase the cross section of the conveying line successively along the conveying path. Account can therefore be taken of the increasing gas volume flow without an unfavourable increase in the gas velocity occurring. Disadvantages of this arrangement include the fact that it is highly complicated and that it is not possible to use uniform line segments over the conveying distance, but rather segments which are always different (becoming larger) have to be supplied and installed in some sections.

DE-B-1 150 320 discloses an apparatus for conveying pulverulent material, in which a supply device for conveying gas is provided at one end of the conveying line. Furthermore, a plurality of fluidizing devices, via which fluidizing gas is introduced into the conveying line, are arranged along the bottom of the conveying pipe. The cross section of the conveying line is substantially constant. An extraction device for the conveying gas is provided on the upper side of the conveying line, in the initial region thereof. Said extraction device serves to generate a stronger air flow at the start of the conveying line such that a greater air flow is available precisely at said point which is critical because of the bulk material being fed in. An increase in the diameter along the conveying line is not provided, and the gas volume which increases because of the supply of fluidizing gas therefore causes a deterioration in the transport properties. There is the risk of the advantageous effect of the fluidization and therefore of the favourable conveying by the conveying gas being lost.

### SUMMARY OF THE INVENTION

Starting from the prior art mentioned last, the invention is based on the problem of providing a conveying apparatus of the type mentioned at the beginning, which improves the conveying capacities and nevertheless manages without a complicated increase in cross section along the conveying distance.

The solution according to the invention resides in features as broadly described herein. Advantageous developments are the subject matter of the embodiments described below.

According to the invention, in the case of an apparatus for pneumatically conveying bulk material, in particular pulverulent material, with a conveying pipe which determines a conveying path for the bulk material, a conveying gas source which is connected to the conveying pipe and is designed for supplying conveying gas in the direction of the conveying path, and at least one removal point which is arranged along the conveying pipe and via which gas is removed from the conveying pipe, it is provided that a plurality of removal points are arranged on the conveying pipe at a distance from one another along the conveying path, and the removal points are adjustable in terms of quantity.

The invention is based on the concept of removing excess gas, in particular conveying gas and/or fluidizing gas, from the conveying pipe. As a result, the volume of the gas is reduced, and therefore an increase in the cross section of the conveying line can be dispensed with. The expansion of the gas, which is unavoidable due to the drop in pressure along the conveying line, is moderated by the invention to an extent such that such a widening of the cross section is no longer required. A further effect achieved in comparison to conventional conveying apparatuses with the conveying line having a constant diameter is that critical values for maintaining the conveying of the flow are avoided. The conveying of the bulk material remains steady and stable. Owing to the removal according to the invention of gas, the conveying apparatus according to the invention, despite the closed conveying pipe, advantageously behaves in a similar manner to a drain with regard to conveying stability. The energy required for operating the conveying apparatus is reduced. In addition, owing to the design according to the invention, the conveying of the bulk material is low in wear. In addition, the undesirable abrasion or destruction of grains in the bulk material is reduced.

Some of the terms used will be explained below:

A conveying pipe is understood as meaning a closed line along which the bulk material which is to be conveyed is transported. The conveying pipe may have a round or an angular cross section or else a cross section which differs therefrom and is designed as desired. The conveying pipe may be laid as desired, in particular it may run horizontally, inclined upwards or else inclined downwards.

A conveying gas source is understood as meaning a device by means of which gas which serves to apply a propulsive force to the bulk material to be conveyed and flows along the conveying path is introduced into the conveying line. In particular, the conveying gas source may be an active element, such as a fan or a compressor. However, it should not be ruled out for the conveying gas source to be a passive element, such as a supply flap in the event of conveying by means of a suction stream.

A removal point is understood as meaning a device via which gas can be removed from the conveying pipe. It is generally arranged in the upper cross-sectional region of the conveying pipe, but this is not compulsory. Along the conveying pipe is understood as meaning an arrangement between the start and the end of the conveying pipe, but not at the start or end.

Adjustable in terms of quantity is understood as meaning that the size of the gas flow removed can be adjusted by means of a controlling element.

The removal point is expediently arranged in the upper region of the cross section of the conveying pipe, to be precise, preferably in the upper third. The effect achieved by this arrangement is that, during removal, as little bulk material as possible is picked up. The portion of bulk material towards the top is reduced depending on the conveying speed or the degree of fluidization achieved.

Furthermore, the removal points are preferably arranged at a distance of at least 50 times, advantageously between 75 times and 150 times the width of the conveying pipe. It has been shown that conveying gas can still be removed to an adequate extent with an arrangement at such large distances.

The removal point expediently has a separating device for conveying gas and bulk material. Entry of bulk material into the removed quantity of gas is therefore prevented. The risk of damage to lines via which the conveying gas is removed is therefore counteracted. In this case, the separating device can be designed as a perforated plate. This has the advantage of a high degree of robustness and wear resistance. However, it can also be provided that the separating device is realized from a woven material. This provides finer grading and therefore separation. The disadvantage resides in the reduced wear resistance. To remedy this, it can also be provided to install the two separating devices combined. It is thereby possible to connect the wear resistance of the perforated plate to the good separating properties of the woven material.

The removal point expediently has a backwashing device. The effect achieved by the backwashing device is that bulk material adhering to the removal point or the separating device thereof can be removed. The risk of the removal point becoming clogged is therefore counteracted.

According to a particularly preferred embodiment, a quantity-regulating device is provided, said quantity-regulating device being connected to the removal points and being designed to regulate the quantity of gas flow removed at the individual removal points. Specific removal at certain points can therefore take place. In this connection, the regulation can advantageously take place as a function of the conveying speed in the conveying line.

Fluidizing points, at which fluidizing gas is supplied via a fluidizing-gas connection, are expediently arranged further along the conveying path. The bulk material is kept in a liquefied state at said fluidizing points. As a result, the expenditure of energy required for transportation is reduced. In this case, a transverse feeding line is expediently provided, said transverse feeding line connecting a removal point to the conveying-gas connection at a fluidizing point placed further along the conveying path. The gas removed can therefore be supplied for further use, namely as a fluidizing gas. As a result, the gas consumption for the fluidizing of the bulk material is reduced. A more favourable method of implementation arises.

It has proven successful to arrange the removal points in an alternating manner with fluidizing points along the conveying pipe. The alternating sequence of gas supply and gas removal along the conveying line evens out the gas flow.

### BRIEF DESCRIPTION OF THE DRAWINGS

The invention is explained below using an advantageous exemplary embodiment and with reference to the attached drawing, in which

FIG. 1 shows a first exemplary embodiment in a schematic view;

FIG. 2 shows a second exemplary embodiment in a schematic view; and

FIG. 3 shows an enlarged illustration of a removal point according to the invention.

### DETAILED DESCRIPTION OF THE INVENTION

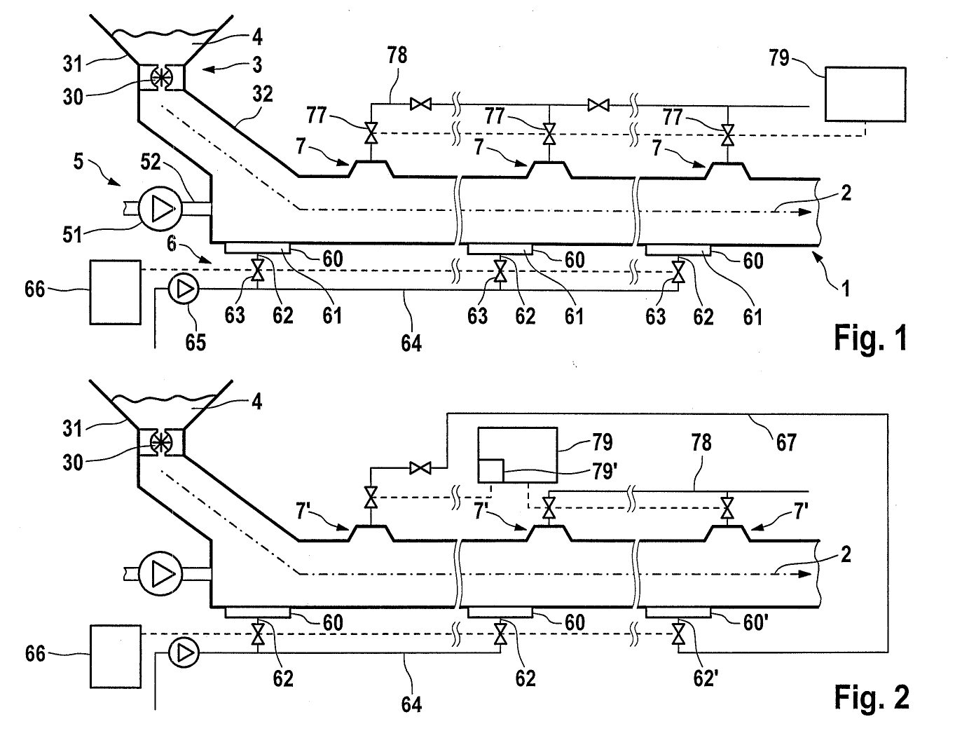

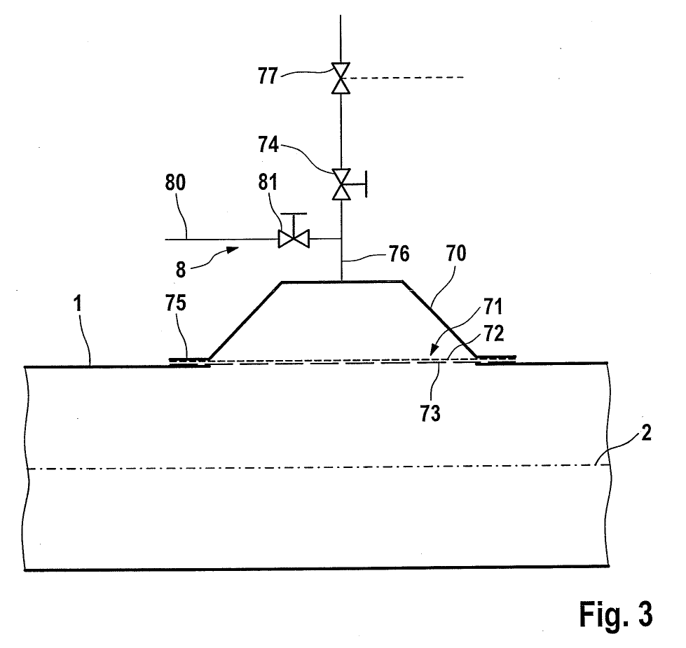

A pneumatic conveying apparatus is illustrated in the exemplary embodiment according to FIG. 1. It comprises an elongated conveying pipe 1 which defines a conveying path 2. A feeding-in point 3 for the bulk material 4 which is to be transported is arranged at the start of the conveying pipe 1. Said feeding-in point comprises a funnel-shaped container 31, at the lower pointed end of which a delivery line 32 leads obliquely downwards to the start of the conveying pipe 1. By means of said bulk-material feeding-in device 3, the bulk material 4 which is to be transported is introduced into the conveying pipe 3 of the conveying device via a pressure lock 30.

A supply device 5 for conveying gas is arranged at the start of the conveying pipe 1. Said supply device comprises a fan 51 which sucks up gas in a manner not illustrated specifically and blows it in via a short delivery line 52 at the beginning of the conveying pipe 1. The blowing-in operation expediently takes place parallel to and as coaxially as possible with respect to the conveying path 2.

The conveying pipe 1, which is only partially illustrated, furthermore has a fluidizing device 6. Said fluidizing device comprises a plurality of fluidizing segments 60, which are arranged along the conveying path 2, on the bottom of the conveying pipe 1. The segments have a cavity 61 which is connected to the interior of the conveying pipe 1 via a gas-permeable diaphragm. Fluidizing gas is supplied into the cavity 61 via a connection 62. The connection 62 comprises a quantity-regulating valve 63. For the supplying of fluidizing gas, a fluidizing-gas fan 65 is provided, said fluidizing-gas fan conducting the fluidizing gas to the connections 62 via a distributing line 64. In order to control the supply of fluidizing gas, a control device 66 which interacts with the quantity-regulating valves 63 is provided.

By the supplying of conveying gas by means of the conveying-gas supply device 5 and the supplying in some sections of fluidizing gas by means of the fluidizing device 6 causes the introduction into the conveying pipe 1 along the conveying path 2 of a continuously increasing quantity of gas which also gains in volume because of expansion.

In the upper region of the conveying pipe 1, a plurality of removal points 7 are distributed, according to the invention, over the length of the conveying pipe 1. In the exemplary embodiment illustrated, said removal points are at a distance from one another that corresponds approximately to 100 times the pipe diameter of the conveying pipe 1. The removal point 7 essentially comprises a tub-like trough 70 which is connected to the interior of the conveying pipe 1 via a gas-permeable separating element 71. The separating element 71 can be of single-layered or multi-layered design. In the exemplary embodiment illustrated, said separating element comprises a woven material 72 for separating the gas which is to be removed from the bulk material 4 which is intended to remain within the conveying pipe 1. To support the woven material 72 and to provide better protection against mechanical wear, a perforated plate 73 is additionally provided for reinforcement purposes. The woven material 72 and the perforated plate 73 are dimensioned in such a manner that they span the entire width of the trough 70 and, by clamping between a flange 75 of the trough and the outside of the conveying pipe 1, are held in a gastight manner by means of a suitable screw connection (not illustrated). It goes without saying that the conveying pipe 1 optionally has a correspondingly worked fixture for better bearing and sealing of the trough 70.

The top of the trough 70 is connected to a removal line 76. Said removal line contains a regulating valve 77 which leads to a collecting line 78.

Furthermore, a control device 79 is provided, the control device acting on the regulating valves 77 of the individual removal points 7. It is therefore possible to provide central control for the individual removal points 7 of the gas quantity to be removed. However, it should not be ruled out that a decentral setting is alternatively or optionally also additionally provided using the individual regulating valves 77.

Furthermore, an optional flushing device 8 is provided at the removal points 7. Said flushing device comprises a delivery line 80 for flushing gas with a first shut-off valve 81 and a second shut-off valve 74 in the line 76. The delivery line 80 leads to the delivery line 76 between the second shut-off valve 74 and the removal point 7. During normal operation, the first shut-off valve 81 is closed and the second shut-off valve 74 is open. If flushing of the removal point 7 is to take place, the corresponding flushing device 8 is actuated by the first shut-off valve 81 being opened and the second shut-off valve 74 being closed. Flushing gas then flows through the line 80, the first shut-off valve 81 and the line 76 into the removal point 7, as a result of which the woven material 72 is cleaned of impurities. A creeping blockade or clogging of the woven material 72 and therefore of the removal point 7 during the course of normal operation is therefore prevented. The flushing device 8 is expediently controlled by a flushing control device (not illustrated).

The second embodiment which is illustrated in FIG. 2 corresponds in its fundamental characteristics to the first embodiment which is illustrated in FIG. 1. Components which correspond bear the same reference numbers. An explanation of the construction thereof and of the functioning thereof is therefore omitted. The main difference between the two embodiments is that some of the removal points (symbolized by the one situated to the extreme left in FIG. 2) are not connected to the collecting line 78, but rather are in each case connected via a cross-feeding line 67 to the supply connection 62 of a fluidizing segment (symbolized here by the fluidizing segment 60′) placed downstream in the direction of the conveying path 2. Said construction uses the gas removed at the removal point 7′ for the purpose of supplying it in the form of fluidizing gas via the cross-feeding line 67 to the fluidizing point 60′. In this case, the fluidizing segment 60′ is selected in such a manner that the fluidizing gas pressure required there for fluidization is at maximum the same magnitude as the pressure of the gas removed at the removal point 7′. The supplying of separate fluidizing gas to the fluidizing segment 60′ is therefore unnecessary. It therefore does not need to be supplied specially by the fluidizing fan 65. As a result, the outlay on operating the conveying apparatus is reduced. The remaining removal points 7 are constructed as in the first exemplary embodiment illustrated in FIG. 1 and are connected to the common collecting line 78. The same applies to the other fluidizing segments 60 which, as explained above in conjunction with FIG. 1, are connected to the fluidizing gas line 64.

The presence of the transverse feeding line does not change the fact that the removal points 7, 7′ are activated by the control device 79. The latter expediently has an additional module 79′ which controls the quantity of gas removed at the removal point 7′ and the feeding thereof into the transverse feeding line 67 for the supply of the fluidizing segment 60′. The controllable supply connections 62 for the fluidizing gas are correspondingly connected to the control device 66 for the fluidization. The additional control module 79′ can advantageously furthermore be designed so as to synchronize with the fluidizing control module 66. For this purpose, a signal line (not illustrated) can be provided. It can therefore be ensured that an amount of gas is always removed at the removal point 7′ sufficient such that at least the quantity required for operating the fluidizing segment 60′ is supplied to the supply connection 62′.

1. An apparatus for pneumatically conveying bulk material comprising:
a conveying pipe which forms a conveying path for the bulk material,
a conveying gas source connected to the conveying pipe and configured to supply conveying gas in the direction of the conveying path, and
a plurality of removal points arranged along the conveying pipe through which gas can be removed from the conveying pipe, wherein the removal points are arranged on the conveying pipe at a distance from one another along the conveying path, and wherein the removal points are adjustable in terms of quantity of gas flow to be removed from the conveying pipe.

2. The conveying apparatus of claim 1, wherein the removal points are arranged in the upper region of a cross section of the conveying pipe.

3. The conveying apparatus of claim 1 or 2, wherein the removal points are arranged at a distance of at least 50 times a diameter of the conveying pipe.

4. The conveying apparatus of claim 2, wherein the removal points have a separating device configured to separate gas and bulk material.

5. The conveying apparatus of claim 4, wherein the separating device comprises a perforated plate.

6. The conveying apparatus of claim 4 or 5, wherein the separating device comprises a gas-permeable woven material.

7. The conveying apparatus of claim 4 or 5, wherein the removal points have a backwashing device.

8. The conveying apparatus of claim 1, wherein a quantity-regulating device is connected to the removal points and configured to regulate the quantity of gas flow removed at the individual removal points.

9. The conveying apparatus of claim 1, wherein fluidizing segments, at which fluidizing gas is supplied via a supply connection, are arranged discontinuously along the conveying path.

10. The conveying apparatus of claim 9, further comprising a transverse feeding line connecting a removal point to the fluidizing-gas supply connection of a fluidizing segment placed downstream in the direction of the conveying path.

11. The conveying apparatus of claim 9 or 10, wherein the removal points are arranged in an alternating manner with the fluidizing segments.

12. The conveying apparatus of claim 1, wherein the bulk material comprises a pulverulent material.

13. The conveying apparatus of claim 2, wherein the removal points are arranged in the upper third of the cross section of the conveying pipe.

14. The conveying apparatus of claim 3, wherein the removal points are arranged at a distance between 75 times and 150 times the diameter of the conveying pipe.
